(19) United States
(12) Patent Application Publication
(10) Pub. No.: US 2022/0350582 A1
(43) Pub. Date: Nov. 3, 2022

(54) SCALABLE SOFTWARE DEPLOYMENT ON AUTONOMOUS MOBILE ROBOTS

(71) Applicant: OhmniLabs, Inc., San Jose, CA (US)

(72) Inventors: Jared GO, Menlo Park, CA (US); Tingxi TAN, Vancouver (CA); Hai DANG, Ho Chi Minh City (VN); Nhat Tan PHAM, Ho Chi Minh City (VN)

(73) Assignee: OhmniLabs, Inc., San Jose, CA (US)

(21) Appl. No.: 17/245,313

(22) Filed: Apr. 30, 2021

(51) Int. Cl. G06F 8/61; G06F 8/65; G06F 9/50; B25J 9/16

(52) U.S. Cl. CPC G06F 8/61; G06F 8/65; G06F 9/5055; G06F 9/5011; B25J 9/1661; G06F 2209/5022

(57) ABSTRACT

Various aspects related to methods, systems, and computer readable media for scalable software deployment on autonomous mobile robots are described herein. A mobile robotics system can include a storage component configured to store a containerized software package, a server in operative communication with the storage component, and, an autonomous mobile robot (AMR) in operative communication with the server. The containerized software installation package is configured to direct the AMR to maneuver to perform at least one robotic task, monitor computational resource usage of resources of the AMR associated with the at least one robotic task, and, responsive to a determination that computational resource usage at the AMR is or will be above a threshold, sending a request to the server to perform a portion of processing tasks such that resource usage at the AMR is reduced to below the threshold or maintained below the threshold.

### TECHNICAL FIELD

Embodiments relate generally to mobile robotics, and more particularly, to methods, systems, and computer readable media for scalable software deployment on autonomous mobile robots.

### BACKGROUND

Mobile robotics platforms typically include a mobile robot configured to execute commands based on an on-board software installation. Generally, the on-board software installation is based upon a prepackaged operating system (OS), such as a mobile operating system or a Linux-based distribution. Prepackaged operating systems allow users of a mobile robot to install components through a documented user interface that allows, for example, installation of various software components designed for the prepackaged OS.

However, when leveraging third-party software components or customized software components, increased development time and other drawbacks may become apparent. For example, third-party software components may not always be authorized for use in prepackaged mobile phone OS distributions; particularly if a prepackaged OS includes security features designed to limit malware or access to physical components, such as a camera.

Furthermore, while some prepackaged OS distributions, such as a Linux-based distribution, may allow installation of almost any software component, such components may require tedious development time and debugging. Moreover, prepackaged OS distributions may generally be designed for a basic configuration of hardware that may or may not be present on a mobile robot. Thus, hardware conflict resolution, resource allotment, and processing/memory bandwidth governing may be absent from any general installation.

### SUMMARY

Implementations of this application relate to methods, systems, and computer readable media for scalable software deployment on autonomous mobile robots. In some implementations, a mobile robotics system comprises: a storage component configured to store a containerized software package; a server in operative communication with the storage component, the server having the containerized software package deployed thereon; and an autonomous mobile robot (AMR) in operative communication with the server, the autonomous mobile robot having the containerized software package deployed thereon, and wherein the deployed containerized software package on the AMR is configured to direct the AMR to perform operations comprising: maneuver the AMR to perform at least one robotic task; monitor resource usage of computational resources of the autonomous mobile robot associated with the at least one robotic task; and responsive to a determination that resource usage at the AMR is above a threshold, send a request to the server to perform a portion of processing tasks such that resource usage of the computational resources at the autonomous mobile robot is reduced to below the threshold.

In some implementations, the containerized software package deployed on the server is configured to direct the server to perform operations comprising: receive the request from the AMR to perform the portion of the processing tasks; performing the portion of the processing tasks, wherein the portion of the processing tasks includes one or more of: processor-related tasks, memory-related tasks, or sensor-related tasks; and transmitting a result of the portion of the processing tasks to the autonomous mobile robot.

In some implementations, the stored containerized software package is configured for independent installation at the autonomous mobile robot and at the server.

In some implementations, the containerized software package deployed at the server and the containerized software installation package deployed at the AMR are identical.

In some implementations, the containerized software package comprises: a device driver component that enables control over one or more physical components of the AMR; a sensor control component that enables reading data from one or more sensors of the AMR; and a maneuvering component that is operable to perform physical maneuvering of the AMR.

In some implementations, the AMR comprises: a hardware processor operable to execute the deployed containerized software package; memory in operative communication with the processor and configured to store the deployed containerized software package; a transceiver component operable to facilitate operative communication between the AMR and the server; and a motion device operable to physically maneuver the AMR.

In some implementations, the AMR further comprises a display device.

In some implementations, directing the AMR to maneuver to perform the at least one robotic task comprises: driving the motion device to physically maneuver the AMR to a predetermined physical location associated with the at least one robotic task.

In some implementations, directing the AMR to monitor resource usage of computational resources of the autonomous mobile robot comprises: monitoring at least one of memory usage of the memory or processor availability of the processor.

In some implementations, responsive to a determination that one or more of memory usage at the AMR is above a memory usage threshold or processing availability at the AMR is below a processing threshold, the containerized software package is configured to direct the AMR to send the request to the server to perform one or more memory-intensive tasks for the autonomous mobile robot.

In some implementations, the AMR is further configured to preemptively offload a portion of processing tasks to the server based on one or more of: processing task dependency, data dependency, or predicted resource usage of the AMR.

In some implementations, the system further comprising a plurality of autonomous mobile robots in operative communication with the server, each autonomous mobile robot having a respective containerized software installation package deployed thereon.

In some implementations, each autonomous mobile robot of the plurality of autonomous mobile robots is configured to offload a portion of one or more of memory-intensive tasks or processing-intensive tasks to the server responsive to resource usage being above the threshold.

In some implementations, the resource usage of the AMR includes one or more of: battery power, compute capacity, available memory capacity, or available storage capacity.

According to another aspect, a computer-implemented method comprises: receiving, at a server, a containerized software package, the containerized software package being associated with an autonomous mobile robot (AMR); deploying, at the server, the containerized software package; receiving, at the server, a request from the AMR to perform a portion of processing tasks associated with the AMR, the request based on one or more of: computational resource usage at the AMR exceeding a threshold or processing dependencies of the portion of the processing tasks; performing the portion of the processing tasks using the deployed containerized software package; and transmitting a result of the portion of the processing tasks to the mobile robot.

In some implementations, the containerized software package comprises: a device driver component that enables control over one or more physical components of the AMR; a sensor control component that enables reading data from one or more sensors of the AMR; and a maneuvering component that is operable to perform physical maneuvering of the AMR.

In some implementations, the processing tasks include one or more of: memory-intensive tasks or processing-intensive tasks that are responsive to resource usage at the AMR being above a threshold.

According to yet another aspect, a computer-implemented method comprises: receiving, at an autonomous mobile robot (AMR) in communication with a server, a containerized software package, wherein the AMR comprises: a processor configured to execute the containerized software package, memory in operative communication with the processor and configured to store the containerized software package, a transceiver component configured to facilitate operative communication between the AMR and the server, and a motion device configured to physically maneuver the AMR; deploying, at the AMR, the containerized software package; executing the containerized software package at the AMR; upon executing the containerized software package, determining that resource usage of computational resources at the AMR is above a threshold; responsive to the determination that the resource usage of computational resources at the AMR is above the threshold, transmitting, from the autonomous mobile robot to the server, a request to perform a portion of processing tasks associated with at least one robotic task; receiving, at the AMR and from the server, a result of the portion of the processing tasks; and completing the at least one robotic task using the result of the portion of the processing tasks.

In some implementations, the containerized software package comprises: a device driver component that enables control over one or more physical components of the AMR; a sensor control component that enables reading data from one or more sensors of the AMR; and a maneuvering component that is operable to perform physical maneuvering of the AMR.

### BRIEF DESCRIPTION OF THE DRAWINGS

FIG. 1 is a diagram of an example network environment for scalable software deployment on autonomous mobile robots, in accordance with some implementations.

FIG. 2 is a diagram of an example physical environment for performing robotic tasks, in accordance with some implementations.

FIG. 3 is a plot of autonomous mobile robot resource utilization, in accordance with some implementations.

FIG. 4 is a flowchart of an example method of scalable software deployment on an autonomous mobile robot, in accordance with some implementations.

FIG. 5 is a schematic of example robotic task and processing task dependencies, in accordance with some implementations.

FIG. 6 is a flowchart of an example method of scalable software execution by a server, in accordance with some implementations.

FIG. 7 is a flowchart of an example method of scalable software execution by an autonomous mobile robot, in accordance with some implementations.

FIG. 8A is a block diagram illustrating an example autonomous mobile robot which may be used to implement one or more features described herein, in accordance with some implementations.

FIG. 8B is a schematic diagram illustrating an example autonomous mobile robot which may be used to implement one or more features described herein, in accordance with some implementations.

FIG. 9 is a block diagram illustrating an example computing device which may be used to implement one or more features described herein, in accordance with some implementations.

### DETAILED DESCRIPTION

One or more implementations described herein relate to scalable software deployment for autonomous mobile robots. Features can include deployment of software such that various processing tasks can be offloaded to a server, by an autonomous mobile robot, based on processor availability, memory availability, storage availability, battery/power status, and/or other factors.

Generally, an autonomous mobile robot (AMR) is a mobile computing platform that can autonomously traverse a physical area to perform one or more robotic tasks. For example, the AMR can traverse a warehouse and scan physical items, traverse a factory floor and retrieve sensor readings/data from sensors mounted at various locations on the factory floor, and otherwise traverse a physical environment to a particular location to perform a robotic task.

While traversing a physical environment, the AMR may utilize onboard resources of the AMR such as: one or more computer processors, memory, storage, battery power, and other resources. However, if the AMR performing task which utilizes the onboard resources to an extent which affects operation of the AMR (e.g., processor utilization causing a drain on battery, storage utilization beyond available capacity, etc.), the AMR may not be capable of fully performing the robotic tasks. Some conventional robotics platforms require an AMR to return to an origin or “home base” to fully charge and subsequently attempt the task again. However, this may have drawbacks such as increased time required to complete tasks; premature wear on components such as battery capacity, motor function, wheels, and other component wear; etc.

According to aspects of the present disclosure, an AMR may instead automatically offload one or more processing tasks to a server. Thereafter, results of the processing tasks as provided by the server may be utilized by the AMR to successfully complete the robotic tasks. Accordingly, technical effects and benefits of the offloaded processing tasks by the AMR may include: better battery life, decreased battery charging cycles, decreased memory and storage utilization, and an ability to perform more complex tasks through an AMR's use of server resources. In this manner, an AMR with otherwise limited capabilities may perform relatively complex, processor-intensive and/or memory-intensive tasks without physically expanding the capabilities of the AMR.

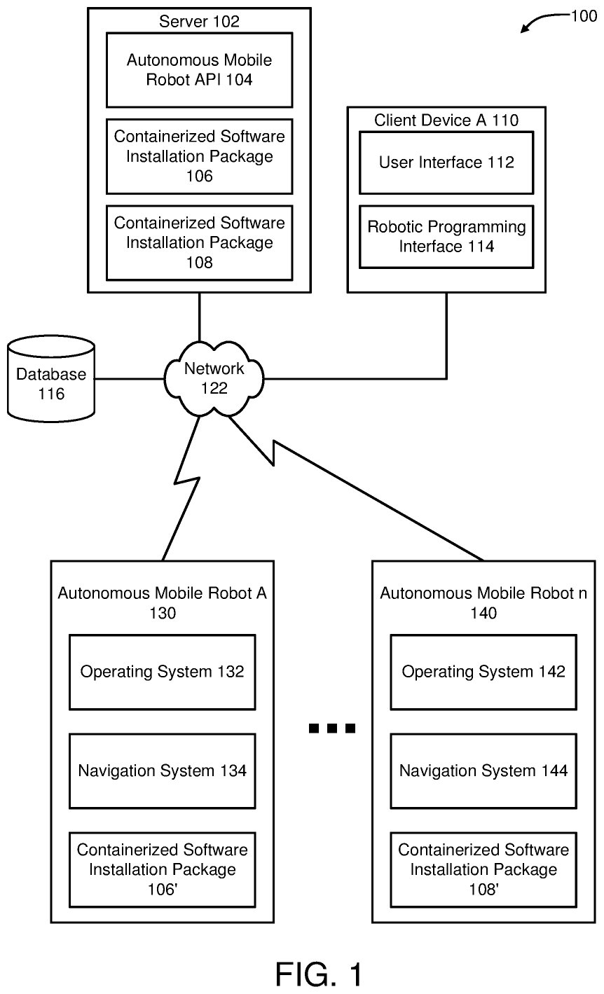

### FIGS. 1 & 2: System Architecture

FIG. 1 illustrates an example network environment 100 for scalable software deployment on autonomous mobile robots, in accordance with some implementations of the disclosure. The network environment 100 (also referred to as “system” herein) includes a server 102, a client device 110, a first AMR A 130, a second AMR n 140 (generally referred to as “AMRs” herein), and a database or data store 116, all coupled via a network 122. The server 102 can include, among other things, an AMR application programming interface (API) 104, and one or more containerized software packages 106 and 108. The client device 110 can include a user interface 112 and a robotic programming interface 114. A user may interact with the client device 110, through the interfaces 112, 114 to develop software applications for deployment on the AMRs 130, 140.

Network environment 100 is provided for illustration. In some implementations, the network environment 100 may include the same, fewer, more, or different elements configured in the same or different manner as that shown in FIG. 1.

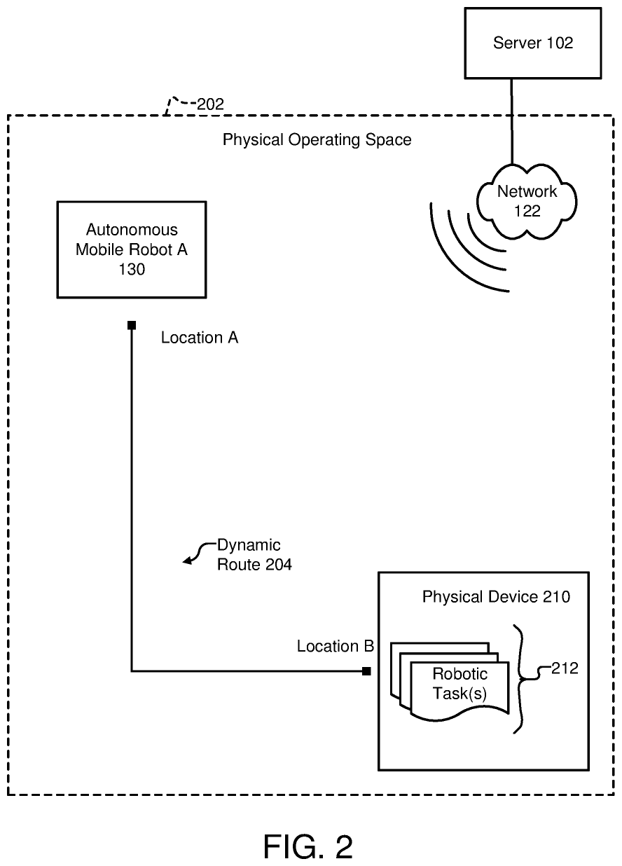

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof. According to some implementations, the network 122 is a private network that allows wired and/or wireless communications in a physical environment (illustrated in FIG. 2).

In some implementations, the data store 116 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the server 102 can include a server having one or more computing devices (e.g., a cloud computing system, a rackmount server, a server computer, a cluster of physical servers, one or more virtual servers, etc.). In some implementations, a server may be an independent system, or be part of another system or platform.

In some implementations, the server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the server 102 and to provide a user with access to server 102. The server 102 may also include a website (e.g., one or more webpages) or application back-end software that may be used to provide a user with access to content provided by server 102. For example, users may access server 102 using the user interface 112.

In some implementations, server 102 may expose the AMR API 104 to client devices (e.g., client device 110) such that program functions, calls, and other features may be used to create or modify a containerized software package 106 and 108. As used herein, containerized software packages refer to software applications that are isolated from one another and bundle their own executable code, software libraries, and configuration files. Accordingly, a containerized software installation package may include all data and logical dependencies in a well-defined manner such that installation and execution of the software is not hindered by lack of access to other resources based on the dependencies.

In some implementations, a containerized software package includes, at least, a device driver component configured to allow control over one or more physical components of the AMR, a sensor control component configured to allow reading data provided by one or more sensors of the AMR, and a maneuvering component configured to perform physical maneuvering of the AMR. Furthermore, the containerized software package is configured to be installed and/or deployed at both the server 102 and a respective AMR 130, 140.

As used herein, “physical maneuvering,” refers to maneuvering or actuating any physical components of the AMR to cause the AMR to perform a physical function. For example, and without limitation, physical maneuvering may include mobility (e.g., moving the AMR) of the AMR, manipulation (e.g., using a tool, arm, sprayer, lamp, or other component) of portions of the AMR, and/or other physical functions. Physical functions can include: spraying an area or environment with a chemical, disinfectant, and/or water from a tank, applying UV light to an area or environment, using a vacuum tool on the AMR to gather material, samples, and/or dust, using a tool (e.g., an end-of-arm tool) to manipulate an object external to the AMR or retrieve objects, using a tool to perform a physical task on the AMR (e.g., replace a camera, spray tank, battery, etc.), and other physical functions. It should be understood that these examples are not exhaustive of all possible physical functions that can be performed by an AMR, and other functions are also applicable.

It should be understood that several technical effects and benefits are realized through implementation of containerized software packages as described herein for use with an AMR. For example, benefits related to modularity and reuse, security, and inheritance.

With regard to modularity and reuse, in some implementations, a robotic task required may include multiple sub-tasks where each sub-task can be handled by a specific containerized software package. For example, for a search and report task, an AMR can re-use two containerized software packages, (e.g., one handles object detection from a vision sensor, and, one handles the exploring and searching motion). Accordingly, with these two rebuilt processes from two containerized software packages, a user only needs to write logic in the User Interface 112 to build/configure this task. This configuration helps separation of concerns, so that each containerized software package can handle a robotic task independently or with configured dependencies. Furthermore, a more complex task can be constructed from sub-tasks that can be more easily reused.

With regard to security, in some implementations, resource usage and data access privileges may be determined for any containerized software packages such that appropriate permissions can be evaluated prior to deployment. This may, for example, reduce security vulnerabilities.

With regard to inheritance, in some implementations, other users or developers can use a rebuilt containerized software package as a foundation, and build a new package which inherited all data content from the foundation containerized software package. In this manner, users do not have to recreate an entire containerized software package from scratch, having tested and functioning containerized package examples with established reliability. These examples of technical benefits and effects are not limiting of all benefits, and further benefits may be realized through use of containerized software packages in autonomous mobile robots.

In some implementations, the server 102 can deploy containerized software installation packages (e.g., 106 and 108) thereon such that the packages may be executed. Furthermore, the server 102 may direct installation and deployment of containerized software installation packages onto any AMR, e.g., AMRs 130 and 140. For example, the containerized software installation package 106 may be retrieved from the data store 116 and deployed at the server 102 and the AMR 130 (illustrated as package 106′). Additionally, the containerized software installation package 108 may be retrieved from the data store 116 and deployed at the server 102 and the AMR 140 (illustrated as package 108′).

It is noted that the server 102 hosting containerized software installation packages 106 and 108 is provided for purposes of illustration, rather than limitation. In some implementations, server 102 may host any number of other software packages and APIs other than those particularly illustrated. Furthermore, according to at least one implementation, functions of the server (including task offloading described herein) may be performed by the client device 110. In these scenarios, the containerized software installation packages 106/108 may be deployed by the client device 110 for installation/deployment at AMRs 130/140. Furthermore, in these scenarios, offloading of tasks may be handled differently as compared to a server. For example, as the AMR is an autonomous mobile robot capable of traversing and manipulating a physical environment without a server, any processing tasks or other tasks that would (in this example) be offloaded to a server, may instead be performed by the AMR in lieu of offloading and/or until a server is available for handling complex processing tasks, data analytics, and other functions.

In some implementations, both the server 102 and AMRs 130, 140 execute an identical containerized software package. The server 102 may perform some or all the containerized software package functions (e.g., generate navigation routes, process sensor data, process images, process obstacle avoidance data, etc.), and may receive requests to perform one or more functions from an individual AMR. In some implementations, AMRs 130, 140 may issue requests to offload processing directly to the server 102, or through an intermediate channel such as a request queue.

For example, the AMR 130 may be associated with one or more robotic tasks. During a sequence of operations related to performing a robotic task, the AMR 130 may monitor resource usage and determine that a threshold has been met or exceeded. Responsive to this determination, the AMR 130 may request the server 102 perform one or more processing tasks such that the resource usage at the AMR 130 is kept below the threshold. Other variations may also be applicable.

For example, the AMR 140 may include particular software dependencies related to individual processing tasks. In this example, when the AMR 140 determines that a processing task to be performed has a particular dependency that may affect resource usage, or is a processing tasks flagged or otherwise denoted as to be performed by the server, the AMR 140 may request the server 102 perform the processing tasks.

As such, AMRs 130, 140 may dynamically request the server 102 perform one or more processing tasks, either based on monitoring resource usage or through other identifiable dependencies, including tasks flagged for server processing. Upon finishing the related processing tasks, the server 102 may return results to the respective AMRs 130, 140 such that associated robotic tasks may be completed.

In some implementations, each AMR may include an operating system 132, 142, a navigation system 134, 144, and one or more containerized software installation packages 106′, 108′, as described above. Generally, the operating system 132, 142 may be an operating system including all suitable software components to enable initialization and use of the AMR. Additionally, the navigation system 134, 144 may be a software system configured to aid and direct the AMR to navigate a physical environment through obstacle avoidance, mapping, route planning, sensor data, and other aspects. Therefore, each AMR is “autonomous” and can navigate physical environments to arrive and one or more destinations to perform one or more robotic tasks. It should be further understood that while described as a “navigation system,” the navigation system 134, 144 may also be or include one or more containerized software packages as described herein.

In general, functions described as being performed by the server 102 can also be performed by the client device 110, in other implementations if appropriate. In addition, the functionality attributed to a particular component can be performed by different or multiple components operating together. The server 102 can also be accessed as a service provided to other systems or devices through appropriate application programming interfaces (APIs), and thus is not limited to use with the particular components illustrated.

In some implementations, server 102 may include a respective navigation system and/or operating system similar to those of each AMR (e.g., 132, 134, 142, 144). As such, the server 102 may perform functions as though from the perspective of the AMR, including processing sensor data, task data, navigation data, obstacle avoidance data, and other similar data.

Thus, the results of processing tasks provided by the server 102 may be used by each AMR 130, 140 to complete respective robotic tasks without excessive battery drainage, processor usage, memory usage, storage utilization, and other factors. Hereinafter, operation of an autonomous mobile robot is described more fully with reference to FIG. 2.

FIG. 2 is a diagram of an example physical environment or operating space 202 for performing robotic tasks, in accordance with some implementations. As illustrated, one or more robotic tasks 212 are associated with a physical device or component 210. For example, the physical device 210 may be an independent sensor, workspace, machine, or other physical device. The associated one or more robotic tasks 212 may include, for example, reading of a sensor, manipulating a valve, or another similar robotic task that is to be performed at a particular location 210 of the physical device or component. It is noted that these examples are illustrative only, and are non-limiting.

In order for the AMR 130 to perform the one or more tasks 212, the AMR may traverse a dynamic route 204 having one or more obstacles and/or turns associated therewith. The AMR 130 may begin physical traversal of the dynamic route 204 at Location A and arrive at Location B, in proximity of the physical device 210. Thereafter, the AMR 130 may perform one or more processing tasks associated with the robotic tasks 212.

For example, the AMR 130 may retrieve a reading of a sensor, gauge, valve, or other device. If, while attempting to perform the robotic task, resource usage at the AMR 130 is above a threshold, the AMR 130 may, using the network 122, request the server 102 perform at least a portion of one or more of the processing tasks such that resource usage at the AMR 130 is reduced to below the threshold. Thereafter, the AMR 130 may receive the results of the processing tasks from the server 102, and complete the robotic tasks 212.

Additionally, the AMR 130 may offload a portion of the processing tasks associated with the robotic tasks 212 to the server 102, and combine its own results with those received from the server in order to perform robotic tasks 212. For example, The AMR 130 may read a current temperature from a sensor and send the temperature data to the server 102. The server 102 may compute an adjustment of a temperature controller to reach a target temperature and send the adjustment to the AMR 130. The AMR 130 may then manipulate a device at the temperature controller to adjust the temperature. It should be understood that this example is illustrative, and other forms of offloading, computation, combination of results, and subsequent action by the AMR are possible.

For example, in some implementations, a user or task designer, when designing/building a robotic task for completion by an AMR, monitors the resource usage (e.g. time completed, memory, CPU, etc.) of the AMR and decides which tasks will be offloaded to the server and which tasks will be performed on the AMR.

For predictive offloading, in some implementations, the AMR can implement a load balancing algorithm to decide which task should be offloaded to the server, or possibly share with another idle AMR. For example, each containerized software package will have a resource consumption score which is correlated to how many resources this package will use when deployed in an environment. The AMR can calculate the total resource consumption score of all deployed containerized software packages at each time. When deploying a new package, the total score will be summed with the new package's score; if it is over a THRESHOLD (set by a user or an indicator that indicates the resource of the AMR is full), the AMR will offload at least a portion of processing tasks associated with this package to the server (or another AMR if the onboard resource consumption score is sufficient for the new package.

It is noted that the resource consumption score of a containerized software package can be set by the designer of the package or can be dynamically calculated by the AMR during deployment of the package by collecting the resource usage metrics of the deployed package. Other predictive offloading routines and algorithms may also be applicable.

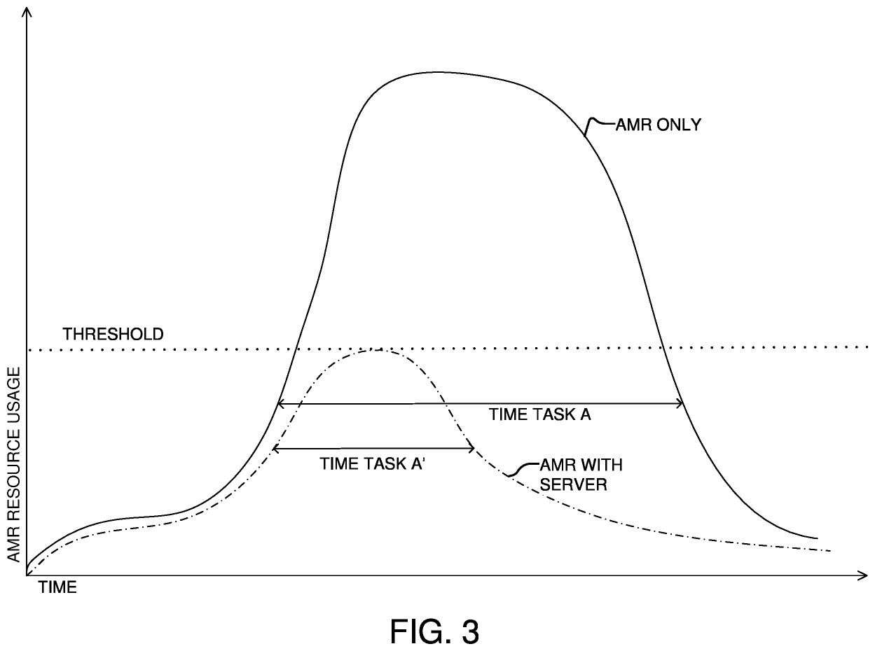

It is noted that the AMR 130 may repeatedly submit requests to the server 102 while in the process of performing robotic tasks 212. As such, while described in a sequential manner, it should be understood that requests and results may be transmitted/received asynchronously. Thus, while the server 102 is performing a first processing task, the AMR 130 may perform a different processing task. Similarly, while the server 102 is performing a processing task, the AMR 130 may leave the proximity of physical device 210 and plan a different dynamic route to a different physical device. Therefore, an overall operating efficiency of the AMR 130 may be increased through intelligent offloading of processing tasks to the server 102, as illustrated in FIG. 3.

### FIG. 3: Technical Benefits and Increased Efficiency

FIG. 3 is a plot of autonomous mobile robot resource utilization, in accordance with some implementations. As shown, an AMR may be directed to perform a TASK A at a physical location. While performing the TASK A, the AMR may utilize resources and cause resource usage above the noted THRESHOLD. Accordingly, the AMR resource utilization over time is relatively large, and may take an amount of time denoted TIME TASK A.

In comparison, the AMR may be directed to perform a TASK A′, which is identical to TASK A. However, upon resource utilization for processing of TASK A′ meeting or exceeding the THRESHOLD, the AMR may offload at least a portion of one or more of the associated processing tasks to the server 102. Accordingly, a time for completion denoted TIME TASK A′ is reduced as compared to TASK A, as the server may perform the offloaded portions of processing tasks more quickly, e.g., due to superior computational resources being available at the server. Furthermore, a total area beneath respective curves, which is representative of total resource usage over time, is reduced compared to an AMR completing TASK A without server resources.

Thus, it is readily apparent that when dynamically and intelligently offloading processing tasks to the server 102, the AMR may utilize less of the constrained on-board resources associated with the AMR. Thus, battery life may be extended and storage resources may be reduced, freeing the AMR to perform other robotic tasks prior to being directed offline for maintenance routines, battery charging, docking, etc.

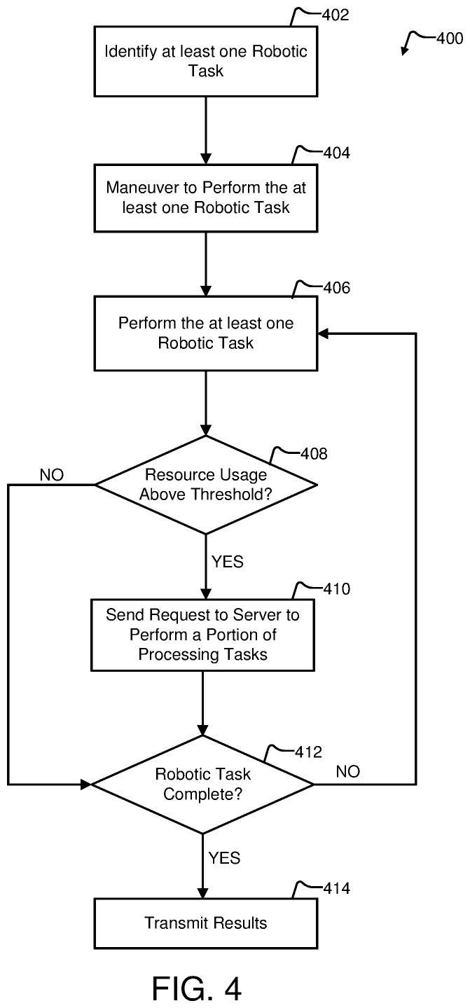

### FIG. 4: Resource Usage Monitoring Methodology

FIG. 4 is a flowchart of an example method 400 of scalable software deployment on autonomous mobile robots, in accordance with some implementations. The method 400 may begin at block 402, where at least one robotic task is identified for an associated AMR. The at least one robotic task may include a plurality of sub-tasks, such as processing tasks. For example, processing tasks may include processing sensor data, processing visual/camera data, processing navigation data, processing obstacle avoidance data, and other processing tasks. Block 402 is followed by block 404.

At block 404, the AMR may be maneuvered to perform the at least one robotic task. For example, a dynamic route 204 may be determined by which the AMR can traverse within a physical space 202 from Location A to Location B. The route may be preplanned in some scenarios, or may be partially static. The route may also be fully dynamic in some scenarios, with on-the-fly processing of visual (e.g., camera feed) data for obstacle avoidance. Other route planning and navigation methodologies may also be applicable. Block 404 is followed by block 406.

At block 406, the AMR may begin to perform the robotic task. For example, the AMR may retrieve a photo of a valve, read a remote sensor, activate a near-field communication device or a proximity sensor, and/or any other suitable action. While performing the task, the AMR may monitor resource utilization of the AMR and its onboard resources. Block 406 is followed by block 408.

At block 408, resource usage of the AMR and its onboard resources are monitored. If resource usage is determined to be above a threshold, block 408 is followed by block 410; else, block 408 is followed by block 412.

At block 410, a request is sent, by the AMR, to the server 102 to perform at least a portion of associated processing tasks. It is noted that the request may also include a request to perform all of the associated processing tasks. Furthermore, the request may also include data dependencies such that the server 102 may perform additional processing tasks, as needed. A response from the server is received and is utilized by the robot in performing the robotic task. For example, the AMR may receive results of the portion of the processing tasks from the server and determine that the task is complete. Block 410 is followed by block 412.

At block 412, the AMR may determine if the robotic task is complete. If the robotic task is complete, block 412 is followed by block 414; else, block 412 is followed by block 414 to continue performing the robotic task.

At block 414, the AMR may transmit associated results to the server 102, e.g., for storage at the data store 116, for display at the user interface 112 of client device 110, or to otherwise tangibly utilize the results.

It is noted that as illustrated with regard to blocks 408 and 412, blocks 406-412 may be repeated and/or iterated as necessary for completion of the at least one robotic task.

As described above, resource monitoring of resources of the AMR may be used to offload at least a portion of processing tasks from an AMR to a server. It is further noted that the same may be varied in many ways to further enhance operation and resource usage of an AMR. For example, robotic tasks may denote dependencies on particular processing tasks such that these tasks are offloaded automatically, prior to resource utilization exceeding the threshold.

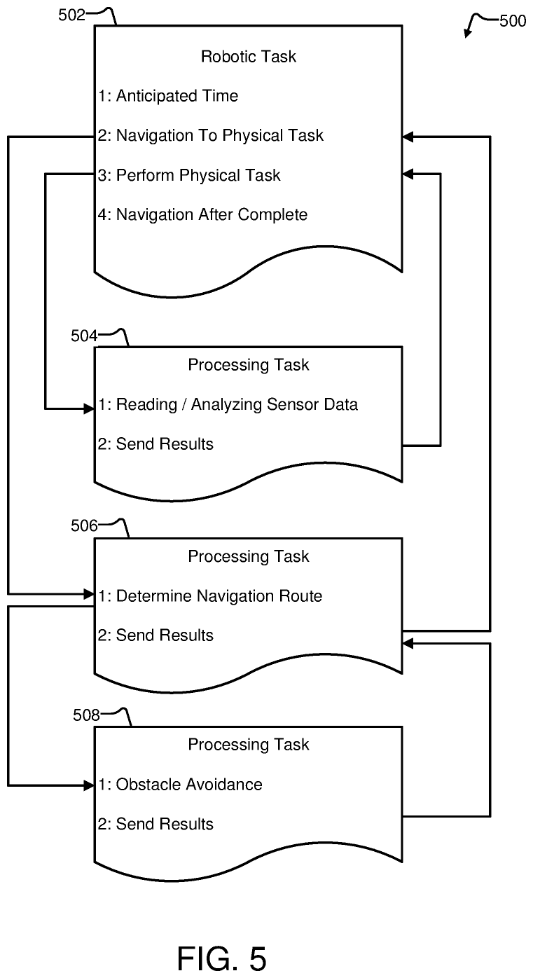

### FIGS. 5-7: Robotic Task Dependencies and Offloading

FIG. 5 is a schematic of example robotic task 502 and processing task dependencies 504, 506, and 508, in accordance with some implementations. As illustrated, the robotic tasks 502 may include various sub-tasks including: determining an anticipated time to completion; reading data from a sensor; analyzing sensor data to determine if a condition is met (e.g., motor is HOT, motor is running at slower than specific speed, motor is running low on fuel, motor is noisier than a threshold); determining a navigation route; analyzing a current location and environment to calculate a path to a destination location that avoids obstacles. As further illustrated, each of the sub-tasks may include associated processing tasks 504, 506, and 508.

For example, processing task 504 may include reading and analyzing of sensor data and returning results; processing task 506 may include determining a navigation route and returning results; and, processing task 508 may include identifying obstacle avoidance data and returning results.

As such, at least a portion of one or more of the processing tasks 504, 506, and 508 may be offloaded to the server 102, whether or not resource usage has exceeded the threshold. In this scenario, the AMR may preemptively offload tasks based on task interdependencies as shown in FIG. 5.

According to some implementations, processing tasks may be distributed by a logical organization of interdependencies such as, for example, a behavioral tree, finite state machine, or other logic. Furthermore, a software or logic manifest may be utilized to define when a particular tasks (e.g., a robotic or processing task) will be performed, as well as a location (e.g., onboard the AMR or offloaded to the server) of the tasks being performed. Furthermore, in some implementations, a server may not be online or available. In these scenarios, the logic manifest, behavioral tree, task interdependencies, and/or finite state machine may direct the AMR to directly perform these tasks immediately, at a delay (e.g., when charging or at a home base), offload once a server is available, and/or may store data related to a processing task for offloading at a later time. Many variations and different dependencies, task distribution, and shared processing task responsibility are possible; accordingly, the particular form and type of task distributions illustrated are non-limiting of all implementations, and only represent one possible form of task distribution.

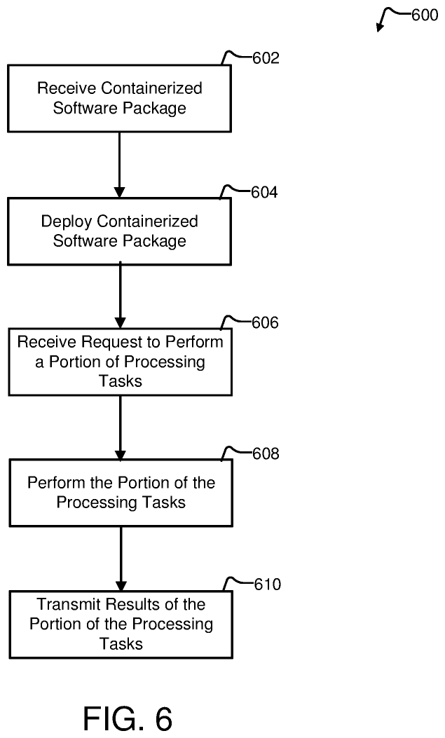

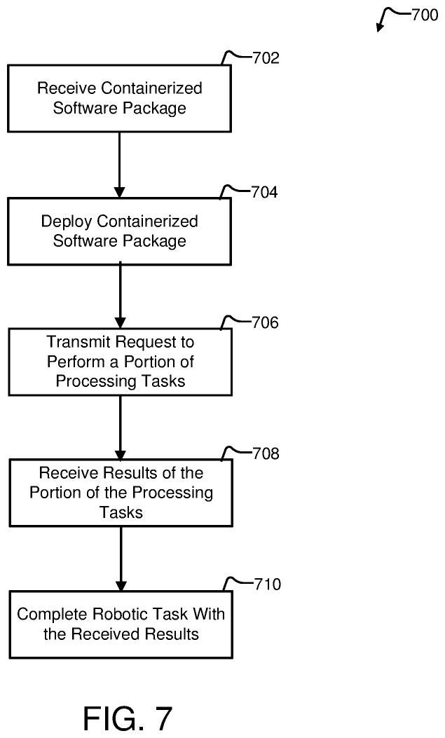

Hereinafter, methods of offloading processing tasks with or without resource usage monitoring are described with reference to FIGS. 6 and 7.

FIG. 6 is a flowchart of an example method 600 of scalable software execution by a server, in accordance with some implementations. The method 600 begins at block 602.

At block 602, a containerized software package is received by the server 102. The containerized software package may be configured as described above, for example, similar to containerized software package 106 and 108. Block 602 is followed by block 604.

At block 604, the containerized software package is deployed at the server 102. For example, the server 102 may install, initialize, and execute all or some of the containerized software package. Block 604 is followed by block 606.

At block 606, a request to perform one or more processing tasks is received at the sever 102. The AMR may send the request based on: resource usage exceeding or nearing the threshold, data or processing dependencies, or a combination of resource usage and dependencies. Block 606 is followed by block 608.

At block 608, the one or more processing tasks are performed at the server 102. Block 608 is followed by block 610.

At block 610, the results of the one or more processing tasks are transmitted by the server 102 to the AMR that made the request.

FIG. 7 is a flowchart of an example method 700 of scalable software execution by an autonomous mobile robot, in accordance with some implementations. The method 700 begins at block 702.

At block 702, a containerized software package is received at an AMR. The containerized software package may be configured as described above, for example, similar to containerized software package 106′ and 108′. Block 702 is followed by block 704.

At block 704, the containerized software package is deployed at the AMR. For example, the AMR may install, initialize, and execute all or some of the containerized software package. Block 704 is followed by block 706.

At block 706, a request to perform one or more processing tasks is transmitted from the AMR, to the sever 102. The AMR may send the request based on: resource usage exceeding or nearing the threshold, data or processing dependencies, or a combination of resource usage and dependencies. Block 706 is followed by block 708.

At block 708, results of the offloaded processing tasks are received at the AMR from the server 102. Block 708 is followed by block 710.

At block 710, the robotic tasks completed by the AMR, utilizing the results received from the server 102.

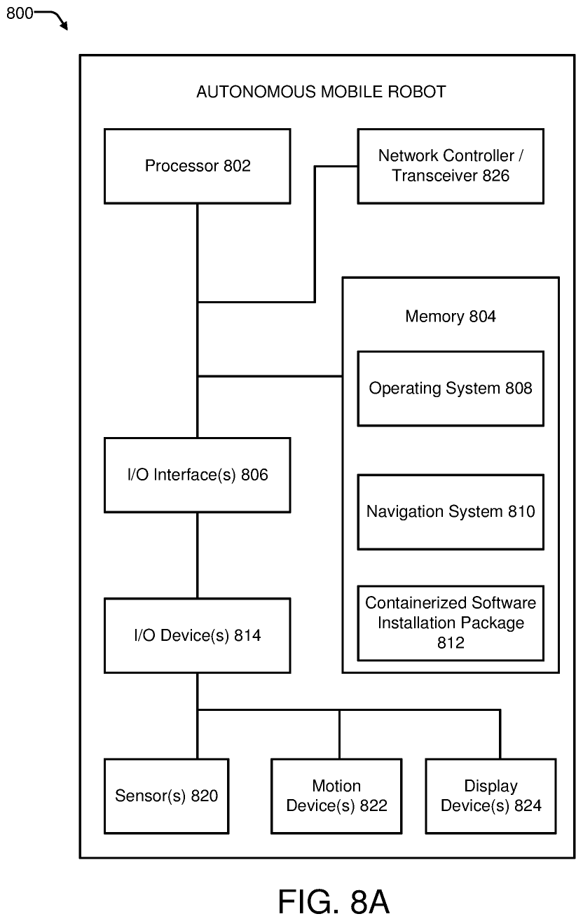

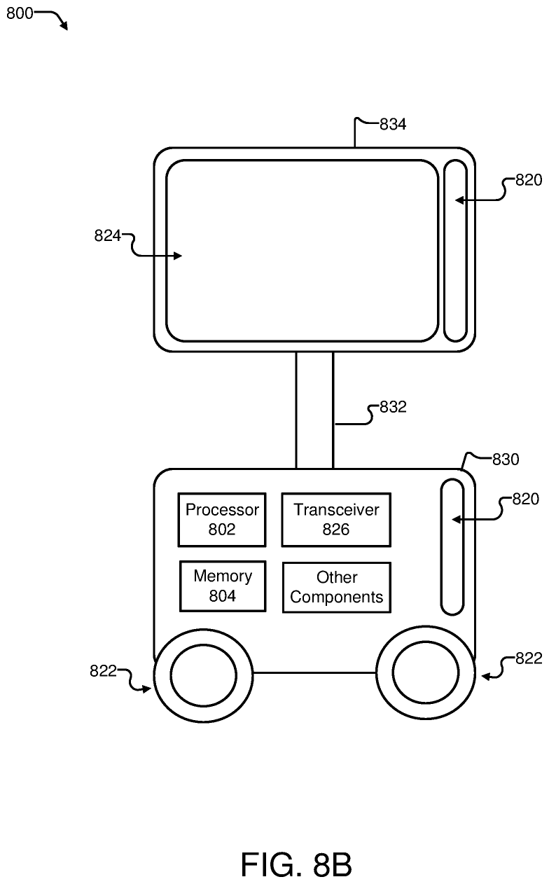

Hereinafter, a more detailed description of autonomous mobile robots that may be used to implement features illustrated in FIGS. 1-7 is provided with reference to FIGS. 8A and 8B.

FIG. 8A is a block diagram of an example autonomous mobile robot (AMR) 800, and FIG. 8B is a schematic of the AMR 800, which may be used to implement one or more features described herein. AMR 800 can be any suitable robotic system, autonomous mobile server, or other robotic device such as, for example, an autonomous telepresence robot. In some implementations, AMR 800 includes a processor 802, a memory 804, input/output (I/O) interface 806, and I/O devices 814.

Processor 802 can be one or more processors and/or processing circuits to execute program code and control basic operations of the AMR 800. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. A processor may perform its functions in “real-time,” “offline,” in a “batch mode,” etc. Portions of processing may be performed at different times and at different locations, by different (or the same) processing systems. A computer may be any processor in communication with a memory.

Memory 804 is typically provided in AMR 800 for access by the processor 802, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 802 and/or integrated therewith. Memory 804 can store software operating on the AMR 800 by the processor 802, including an operating system 808, a navigation system 810, and a containerized software installation package 812.

Memory 804 can include software instructions for the containerized software packages 106′, 108′, as described with reference to FIG. 1. Any of software in memory 804 can alternatively be stored on any other suitable storage location or computer-readable medium. In addition, memory 804 (and/or other connected storage device(s)) can store instructions and data used in the features described herein. Memory 804 and any other type of storage (magnetic disk, optical disk, magnetic tape, or other tangible media) can be considered “storage” or “storage devices.”

I/O interface 806 can provide functions to enable interfacing the AMR 800 with other systems and devices. For example, network communication devices, storage devices (e.g., memory and/or data store 116), and input/output devices can communicate via interface 806. In some implementations, the I/O interface can connect to interface devices 814 including one or more of: sensor(s) 820, motion device(s) 822 (e.g., motors, wheels, tracks, etc.), display device(s) 824 (e.g., a mounted tablet, phone, display, etc.), and a network controller/transceiver 826.

For ease of illustration, FIG. 8A shows one block for each of processor 802, memory 804, I/O interface 806, software blocks 808-812, and devices 820-826. These blocks may represent one or more processors or processing circuitries, operating systems, memories, I/O interfaces, applications, and/or software modules. In other implementations, AMR 800 may not have all of the components shown and/or may have other elements including other types of elements instead of, or in addition to, those shown herein.

Turning to FIG. 8B, a schematic of the AMR 800 is provided. As shown, the AMR includes a main body 830, a support structure 832 attached to the main body 830, and a display structure 834 attached to the support structure 832. The support structure may be a telescoping structure configured to raise/lower the display structure 834 to differing heights above the main body 830.

Generally, the main body 830 may house and protect the components illustrated, such as the processor 802, memory 804, network device/transceiver 826, and/or other devices. Furthermore, sensor devices and other I/O devices 820 may be distributed on the main body 830, support structure 832, and/or display structure 834. Additionally, wheels may be included as an implementation of the motion devices 822, although other motion devices such as: actuators, solenoids, end-of-arm tooling, telescoping apparatuses, tracks, treads, and other devices may also be applicable. Furthermore, although described as motion devices, it should be understood that modular devices, add-on components, and other features may be applicable. For example, external lighting, UV lights/lamps, aerosol pumps, spray devices, speaker/sound devices, and other components may be included or interfaced with an AMR 800 without departing from this disclosure.

The AMR 800 may be fully or partially autonomous, and may navigate routes in a physical space or area based on instructions processed at processor 802. The AMR 800 may further utilize onboard resources as described above, and offload a portion of some or all of processing tasks (e.g., using the transceiver 826) as further described above, to a server and/or computer device.

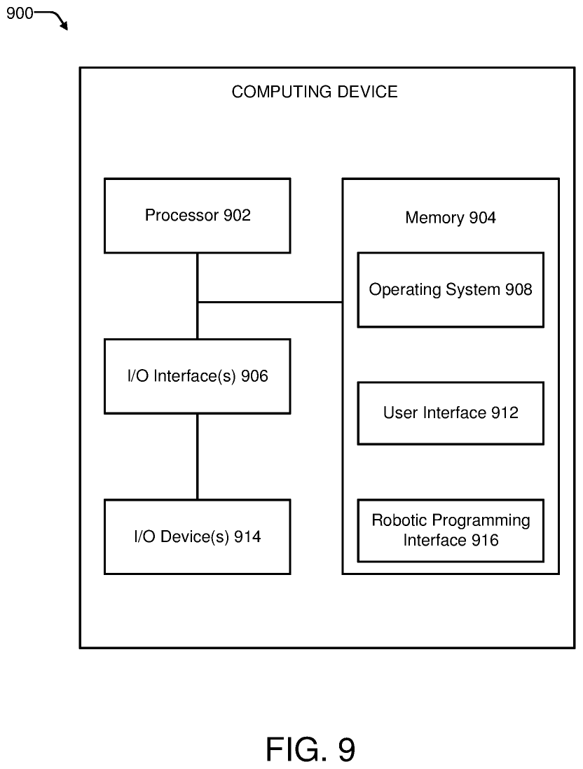

Hereinafter, a more detailed description of various computing devices that may be used to implement different devices (e.g., the server 102 and/or client device 110) illustrated in FIG. 1, is provided with reference to FIG. 9.

FIG. 9 is a block diagram of an example computing device 900 which may be used to implement one or more features described herein, in accordance with some implementations. In one example, device 900 may be used to implement a computer device, (e.g., 110 of FIG. 1), and perform appropriate method implementations described herein. Computing device 900 can be any suitable computer system, server, or other electronic or hardware device. For example, the computing device 900 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 900 includes a processor 902, a memory 904, input/output (I/O) interface 906, and audio/video input/output devices 914 (e.g., display screen, touchscreen, display goggles or glasses, audio speakers, microphone, etc.).

Processor 902 can be one or more processors and/or processing circuits to execute program code and control basic operations of the device 900. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 904 is typically provided in device 900 for access by the processor 902, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 902 and/or integrated therewith. Memory 904 can store software operating on the server device 900 by the processor 902, including an operating system 908, a user interface 912, and a robotic programming interface 916.

Memory 904 can include software instructions for a robotic programming interface to create a containerized software installation program 106, 106′, 108, 108′, as described with reference to FIG. 1. Any of software in memory 904 can alternatively be stored on any other suitable storage location or computer-readable medium. In addition, memory 904 (and/or other connected storage device(s)) can store instructions and data used in the features described herein. Memory 904 and any other type of storage (magnetic disk, optical disk, magnetic tape, or other tangible media) can be considered “storage” or “storage devices.”

I/O interface 906 can provide functions to enable interfacing the server device 900 with other systems and devices. For example, network communication devices, storage devices (e.g., memory and/or data store 116), and input/output devices can communicate via interface 906. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 9 shows one block for each of processor 902, memory 904, I/O interface 906, software blocks 908, 912, and 916, and database 912. These blocks may represent one or more processors or processing circuitries, operating systems, memories, I/O interfaces, applications, and/or software modules. In other implementations, device 900 may not have all of the components shown and/or may have other elements including other types of elements instead of, or in addition to, those shown herein. While the server 102 is described as performing operations as described in some implementations herein, any suitable component or combination of components of server 102 or similar system, or any suitable processor or processors associated with such a system, may perform the operations described.

A user device can also implement and/or be used with features described herein. Example user devices can be computer devices including some similar components as the device 900, e.g., processor(s) 902, memory 904, and I/O interface 906. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 914, for example, can be connected to (or included in) the device 900 to display images, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices, servers, and autonomous mobile robots (AMRs). In some implementations, one or more methods described herein can be implemented, for example, on a server system with a dedicated AMR, and/or on both a server system and any number of AMRs. In some implementations, different components of one or more servers and/or AMRs can perform different blocks, operations, or other parts of the methods.

One or more methods described herein (e.g., methods 400, 600, and/or 700) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A mobile robotics system, comprising:
a storage component configured to store a containerized software package;
a server in operative communication with the storage component, the server having the containerized software package deployed thereon; and
an autonomous mobile robot (AMR) in operative communication with the server, the autonomous mobile robot having the containerized software package deployed thereon, and wherein the deployed containerized software package on the AMR is configured to direct the AMR to perform operations comprising:
maneuver the AMR to perform at least one robotic task;
monitor resource usage of computational resources of the autonomous mobile robot associated with the at least one robotic task; and
responsive to a determination that resource usage at the AMR is above a threshold, send a request to the server to perform a portion of processing tasks such that resource usage of the computational resources at the autonomous mobile robot is reduced to below the threshold.

2. The system of claim 1, wherein the containerized software package deployed on the server is configured to direct the server to perform operations comprising:
receive the request from the AMR to perform the portion of the processing tasks;
performing the portion of the processing tasks, wherein the portion of the processing tasks includes one or more of: processor-related tasks, memory-related tasks, or sensor-related tasks; and
transmitting a result of the portion of the processing tasks to the autonomous mobile robot.

3. The system of claim 1, wherein the stored containerized software package is configured for independent installation at the autonomous mobile robot and at the server.

4. The system of claim 3, wherein the containerized software package deployed at the server and the containerized software installation package deployed at the AMR are identical.

5. The system of claim 1, wherein the containerized software package comprises:
a device driver component that enables control over one or more physical components of the AMR;
a sensor control component that enables reading data from one or more sensors of the AMR; and
a maneuvering component that is operable to perform physical maneuvering of the AMR.

6. The system of claim 1, wherein the AMR comprises:
a hardware processor operable to execute the deployed containerized software package;
memory in operative communication with the processor and configured to store the deployed containerized software package;
a transceiver component operable to facilitate operative communication between the AMR and the server; and
a motion device operable to physically maneuver the AMR.

7. The system of claim 6, wherein the AMR further comprises a display device.

8. The system of claim 6, wherein directing the AMR to maneuver to perform the at least one robotic task comprises:
driving the motion device to physically maneuver the AMR to a predetermined physical location associated with the at least one robotic task.

9. The system of claim 6, wherein directing the AMR to monitor resource usage of computational resources of the autonomous mobile robot comprises:
monitoring at least one of memory usage of the memory or processor availability of the processor.

10. The system of claim 9, wherein responsive to a determination that one or more of memory usage at the AMR is above a memory usage threshold or processing availability at the AMR is below a processing threshold, the containerized software package is configured to direct the AMR to send the request to the server to perform one or more memory-intensive tasks for the autonomous mobile robot.

11. The system of claim 1, wherein the AMR is further configured to preemptively offload a portion of processing tasks to the server based on one or more of: processing task dependency, data dependency, or predicted resource usage of the AMR.

12. The system of claim 1, further comprising a plurality of autonomous mobile robots in operative communication with the server, each autonomous mobile robot having a respective containerized software installation package deployed thereon.

13. The system of claim 12, wherein each autonomous mobile robot of the plurality of autonomous mobile robots is configured to offload a portion of one or more of memory-intensive tasks or processing-intensive tasks to the server responsive to resource usage being above the threshold.

14. The system of claim 1, wherein the resource usage of the AMR includes one or more of:
battery power, compute capacity, available memory capacity, or available storage capacity.

15. A computer-implemented method, comprising:
receiving, at a server, a containerized software package, the containerized software package being associated with an autonomous mobile robot (AMR);
deploying, at the server, the containerized software package;
receiving, at the server, a request from the AMR to perform a portion of processing tasks associated with the AMR, the request based on one or more of: computational resource usage at the AMR exceeding a threshold or processing dependencies of the portion of the processing tasks;
performing the portion of the processing tasks using the deployed containerized software package; and
transmitting a result of the portion of the processing tasks to the mobile robot.

16. The computer-implemented method of claim 15, wherein the containerized software package comprises:
a device driver component that enables control over one or more physical components of the AMR;
a sensor control component that enables reading data from one or more sensors of the AMR; and
a maneuvering component that is operable to perform physical maneuvering of the AMR.

17. The computer-implemented method of claim 15, wherein the processing tasks include one or more of: memory-intensive tasks or processing-intensive tasks that are responsive to resource usage at the AMR being above a threshold.

18. A computer-implemented method, comprising:
receiving, at an autonomous mobile robot (AMR) in communication with a server, a containerized software package, wherein the AMR comprises: a processor configured to execute the containerized software package, memory in operative communication with the processor and configured to store the containerized software package, a transceiver component configured to facilitate operative communication between the AMR and the server, and a motion device configured to physically maneuver the AMR;
deploying, at the AMR, the containerized software package;
executing the containerized software package at the AMR;
upon executing the containerized software package, determining that resource usage of computational resources at the AMR is above a threshold;
responsive to the determination that the resource usage of computational resources at the AMR is above the threshold, transmitting, from the autonomous mobile robot to the server, a request to perform a portion of processing tasks associated with at least one robotic task;
receiving, at the AMR and from the server, a result of the portion of the processing tasks; and
completing the at least one robotic task using the result of the portion of the processing tasks.

19. The computer-implemented method of claim 18, wherein the containerized software package comprises:
a device driver component that enables control over one or more physical components of the AMR;
a sensor control component that enables reading data from one or more sensors of the AMR; and
a maneuvering component that is operable to perform physical maneuvering of the AMR.
